(19) United States
(12) Patent Application Publication
(10) Pub. No.: US 2005/0057502 A1
(43) Pub. Date: Mar. 17, 2005

(54) Joystick controller for cellular telephone

(76) Inventors: Theodore R. Arneson, Ivanhoe, IL (US); Richard J. Dombrowski, Libertyville, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/652,217

(22) Filed: Aug. 29, 2003

(51) Int. Cl. G09G 5/08

(52) U.S. Cl. 345/161

(57) ABSTRACT

A joystick that is retractable within a cellular telephone includes a multi-directional input device, and a shaft extending up from the multi-directional input device. The multi-directional input device is adapted to read a direction in which the shaft pushed. A handle is disposed over the shaft, wherein the handle is selectable between a retracted position and an extended position. A loudspeaker may be included within the handle.

### FIELD OF THE DISCLOSURE

This patent relates generally to control devices for cellular telephones, and particularly, to a retractable joystick for a cellular telephone.

### BACKGROUND OF THE DISCLOSURE

As technology increases the capabilities of cellular telephones, consumers are demanding cellular telephones to perform more functions. These functions include text messaging, e-mailing, and, increasingly, gaming.

Present cellular telephones that are capable of playing games are simple spin-offs of existing form factor handsets. These cellular telephones incorporate a four-way directional input, i.e., up, down, left or right. This is adequate for games such as poker, or merely maneuvering through on-screen menus. However, as demand for gaming has grown and the complexity of games has increased, a need has developed for increased user input capabilities.

As can be seen in other video game consoles such as Sony Playstation® or X-Box®, a common user input method is the joystick. Games played on these systems are of higher complexity and require a far more precise directional control common to the aforementioned systems. These joysticks include a multi-directional controller that can read any direction in which the joystick is pushed, and the distance it has been pushed.

However, a joystick that could be used in a cellular telephone would have the problem of damage to the joystick due to its protruding nature from the protection of the housing. The joystick could easily be damaged if the user dropped the cellular telephone. The joystick could also catch on items such as a jacket pocket while the cellular telephone is being transported and also could be uncomfortable to carry in a pocket.

Another problem is the joystick can take up a sizeable portion of the surface area of a cellular telephone. This is increasingly so with the ever diminishing size of cellular telephones. However, each cellular telephone must include a speaker such that a user can hear the person with whom they are speaking. In some small cellular telephones, even without joysticks, it has been found difficult to place a speaker—the speaker ends up mounted on the side or rear of the handset. Thus, a cellular telephone that includes a joystick may leave little, if any, room for a speaker. This can create poor acoustics and lower the overall quality of the cellular telephone, as acoustics are critical to customer satisfaction.

### BRIEF DESCRIPTION OF THE DRAWINGS

The invention will become more fully understood from the following detailed description, taken in conjunction with the accompanying drawings.

FIG. 1 is a perspective view of a cellular telephone with a retractable joystick.

FIG. 2 is a partial elevational view of the cellular telephone of claim 1 with the joystick in the extended position.

FIG. 3 is a partial elevational view of the cellular telephone of claim 1 with the joystick in the retracted position.

FIG. 4 is an fragmentary cross-sectional view of the joystick, taken along line 4-4 in FIG. 2.

FIG. 5 is a perspective view of an example of a multi direction input device.

FIG. 6 is a detail perspective view of a potentiometer of the multi direction input device.

FIGS. 7, 8, 9, and 10 are sequential perspective views of the joystick between the extended position and the retracted position.

FIG. 11 is an cross sectional elevational view of a second example of a retractable joystick in the down position.

FIG. 12 is an exploded view of the joystick of FIG. 11.

FIG. 13 is a cross sectional elevational view of the joystick of FIG. 11 in the up position.

### DETAILED DESCRIPTION

FIG. 1 illustrates a cellular telephone 10 according to an example of this disclosure. Although in this specification a cellular telephone 10 is described, it is clear that any personal communication device, such as a pager or wireless personal digital assistant could incorporate the teachings of this disclosure to advantageously increase the ability of a user to input information into the device.

As depicted in FIG. 1, the cellular telephone 10 includes a housing 11 on which is disposed a plurality of keys 12, a display screen 14, and a retractable joystick 18. The keys 12 can be used to input information into the cellular telephone 10 by pressing individual buttons 13. For example, the keys 12 can perform various functions, such as ending a call, calling up a menu, or selecting an item from a menu. In another example not shown, the keys 12 can include a standard keypad. In this example, the keys 12 can be used to enter a telephone number.

The display screen 14 provides a visual display of information to the user. This includes, for example, time and date, the phone numbers being called or received, and selectable menu items such as a personal phone book, phone numbers of recent calls, or video games played by the user of the cellular telephone 10. In this example, the display screen 14 is also touch-sensitive. Accordingly, the user may input information such as telephone numbers to be called by touching icons presented on the display screen.

The disclosed configuration of the keys 12 and display screen 14 are not particular to the invention and any suitable arrangement or combination may be used.

The retractable joystick 18 can be used as a user input device to navigate through the menus shown on the display screen 14 and further can be used, as is well known, in the playing of video games. The joystick 18 can include a knob 20 that can be grasped by the user. The knob 20 includes a top surface 22 with a depression 24 such that a user can easily place his or her thumb or any other finger onto the top surface 22 and into the depression 24 to increase control of the joystick 18.

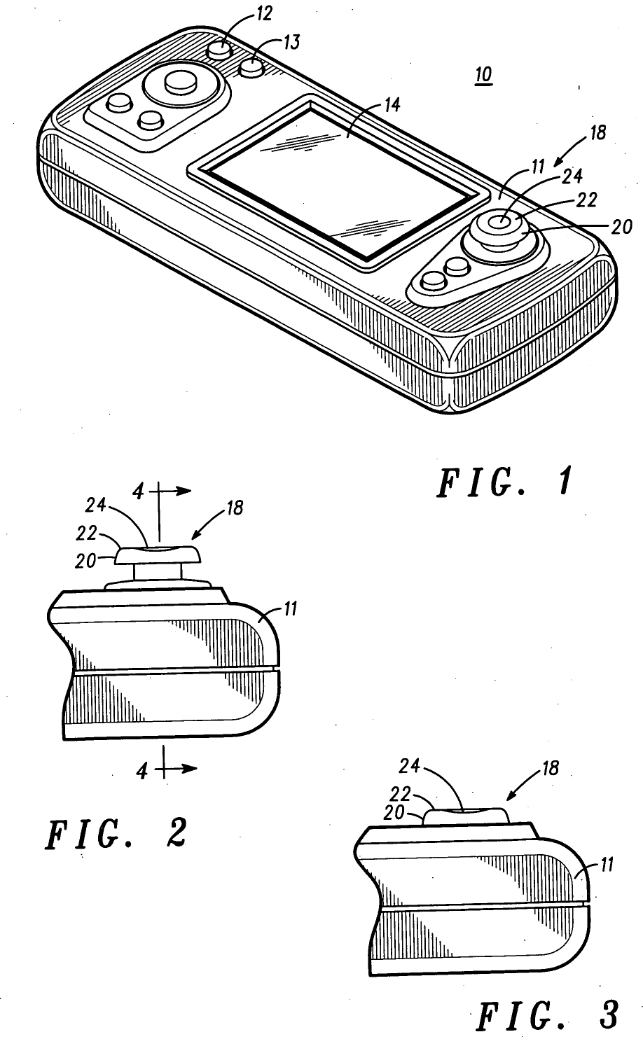

As can be seen from FIGS. 2 and 3, the joystick 18 is retractable from an extended or “up” position, shown in FIG. 2, in which the knob 20 of the joystick 18 is extended above the housing 11, to a retracted or “down” position, in which the knob 20 of the joystick 18 is retracted to a position such that the top surface 22 is approximately flush with the housing 11 or extends minimally.

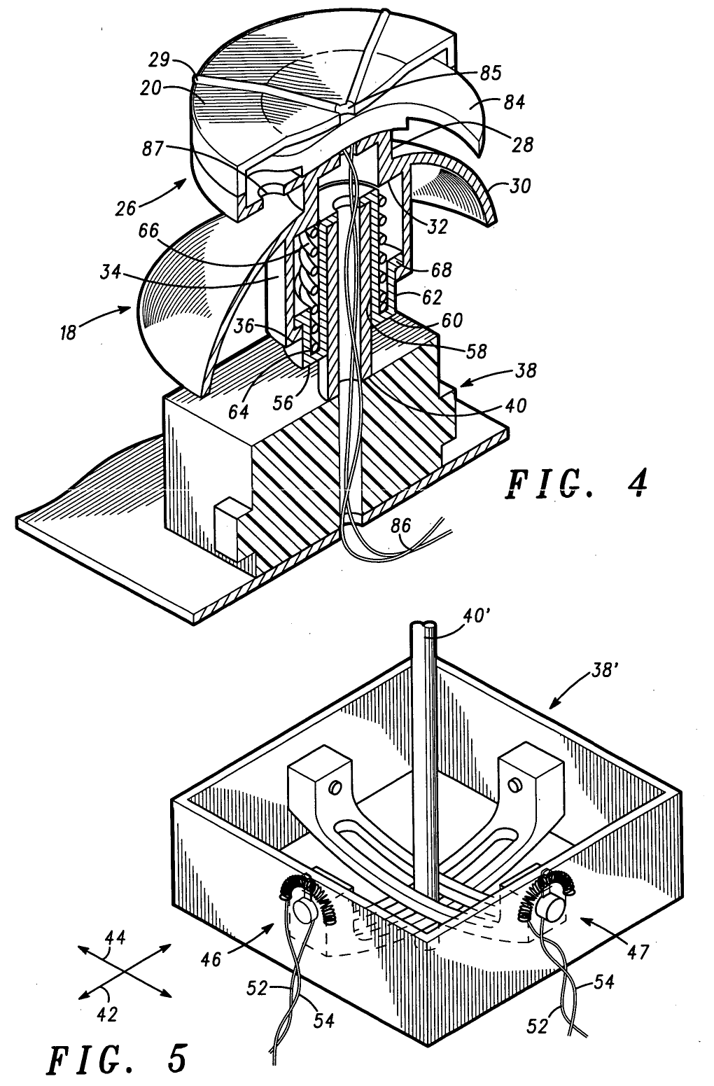

FIG. 4 depicts a cross sectional view of the joystick 18. The joystick 18 includes a handle 26, which is defined by the knob 20, a neck 28 connected to the knob 20, and a skirt 30 which is in turn connected to the neck 28. The knob can include a plurality of ridges 29 that can be used in rotating the handle 26, as will be described later. The skirt 30 can have a constant radius of curvature or be in a generally spherical shape and is adapted to bear against the inside of the housing 11 as the joystick 18 is maneuvered. On the bottom of the skirt 30 is a bearing surface 32 and at least one downward extending sliding tab 34, each sliding tab 34 including an inward extending sliding lip 36.

A multi-directional input device 38 is fixed to the housing 11 of the cellular telephone 10. Extending upward from the multi-directional input device 38 is a shaft 40. Although the multi-directional input device 38 is shown in block form in FIG. 4, details of a simplified example of a multi-directional input device 38′ and shaft 40′ are shown in FIGS. 5 and 6. While the multi-directional input device 38′ shown in FIGS. 5 and 6 is appropriate for use with the cellular phone 10, this is merely an example. Any form of a multi-directional input device that can read a direction inputted by a user, such as those with optical sensors, trackballs, micro control sticks, and others known in the art, can be also be used.

In the multi-directional input device 38′, the shaft 40′ can be rotated about an X-axis 42 and a Y-axis 44. A first potentiometer 46 can be disposed to rotate about the X-axis 42, and a second potentiometer 47 can be disposed to rotate about the Y-axis 44. Both the first potentiometer 46 and the second potentiometer 47 include a contact arm 48 and a resistor track 50. As the shaft 40′ is rotated about an axis 42, 44, the contact arm 48 is rotated along the resistor track 50 associated with that axis 42, 44. Electric current flows in series through a first wire 52, the resistor track 50, the contact arm 48, and a second wire 54. The further the shaft 40′ is rotated, the further the current must travel through the resistor track 50, thereby increasing the resistance across and decreasing the current flow through the circuit. Accordingly, the angle of rotation of the shaft 40′ about each axis 42, 44, and thus the direction the user is pointing the shaft 40′ can be determined by the resistances across and current flow through the circuits.

Referring back to FIG. 4, a base 56 is fixedly disposed on the shaft 40. The base 56 includes a fixed cylinder 58 fixed directly to the shaft 40, a fender 60 extending out from the fixed cylinder 58, and a locking cylinder 62 extending up from the fender 60. The fixed cylinder 58, fender 60, and locking cylinder 62 combine to define a cylindrical slot 64. A spring 66 can be disposed in the cylindrical slot 64 such that a first end of the spring 66 is against the fender 60, while the second end of the spring 66 is against the bearing surface 32 of the skirt 30.

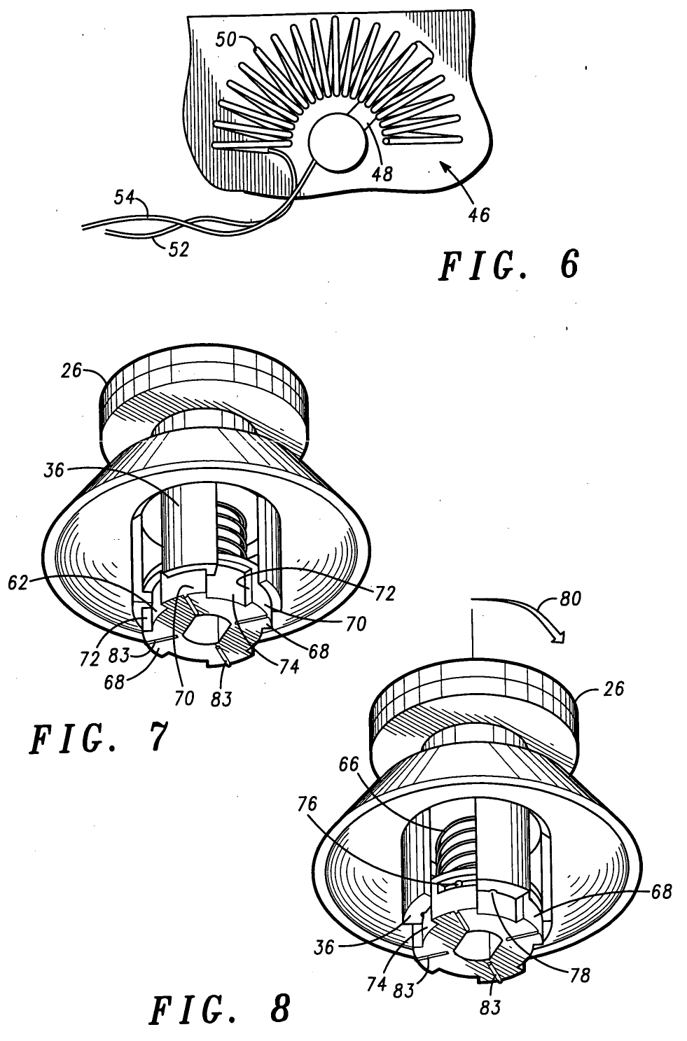

The locking cylinder 62 includes locking struts 68 that extend outwardly from the locking cylinder 62. As best seen in FIG. 7, the locking struts 68 each include a footer 70 and a riser 72. The locking struts 68 of the locking cylinder 62 interact with the sliding lips 36 on the handle 26 to allow the handle 26 to extend and retract vertically between an extended position, or “up” position, and a retracted position, or “down” position, and further be secured in either position. Channels 74 are defined by the passageways between the locking struts 62. The handle 26 can be made from an resilient plastic such as polycarbonate to facilitate a snap fit.

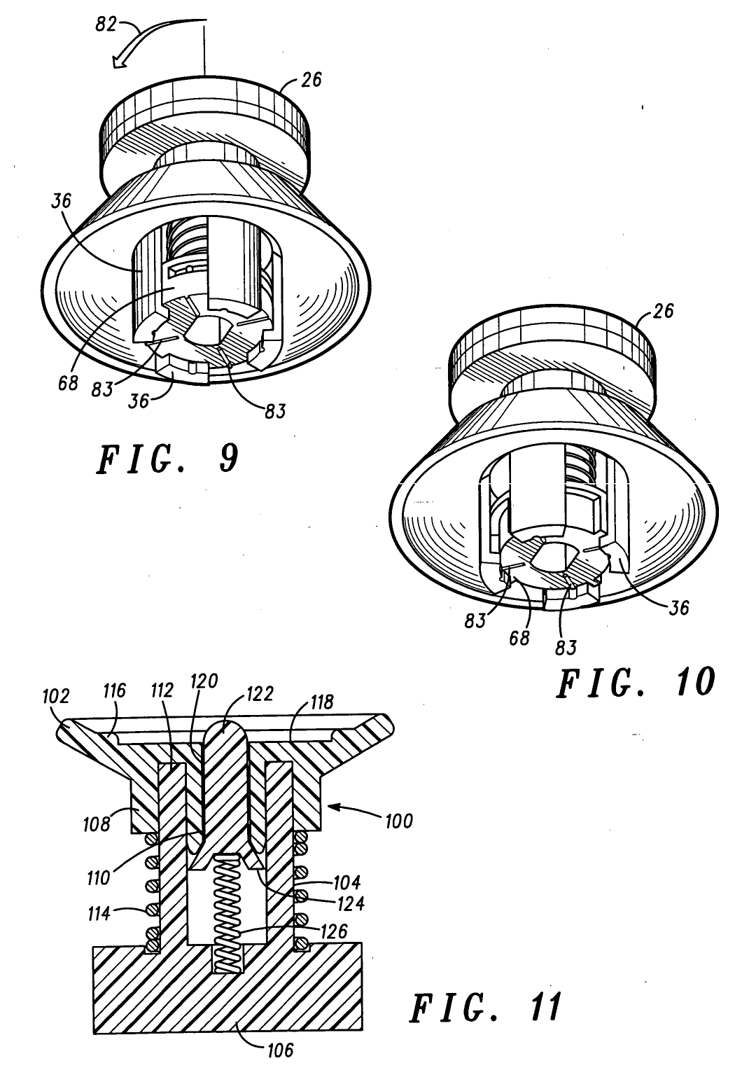

Referring to FIG. 7, the handle 26 is shown in the extended position. In this position, the sliding lips 36 are disposed on top of the footers 70 and against the risers 72 of the locking struts 68. Thus, any downward force exerted by the user on the handle 26 is directed through the locking struts 68 to the base 56, which is fixed and maintains the handle 26 in the extended position. Disposed on the locking cylinder 62 above the footers 70 is a nubbin 76 (best seen in FIG. 8). The sliding lips 36 each include a receiver 78 that surrounds the nubbin 76 when the handle 26 is in the extended position, thereby snapping the sliding lip 36 into place and helping to maintain the handle 26 in this position.

FIGS. 8, 9, and 10 depict the sequence of steps that can be taken to place the handle 26 in the retracted position. In FIG. 8, the handle 26 has been rotated in a counterclockwise direction, indicated by a first rotational arrow 80, such that the sliding lips 36 are in alignment with the channels 74. In this position, the handle 26 is only maintained upward by the force of the spring 66.

As shown in FIG. 9, the handle 26 has been pushed downward into the housing 11 of the cellular telephone 10. The sliding lips 36 have been pushed downward through the channels 74 and below the level of the locking struts 68.

At this point, the handle 26 can be rotated in a clockwise direction, as indicated by a second rotational arrow 82, to place the handle in the position shown in FIG. 10. In this position, the sliding lips 36 are disposed directly beneath the locking struts 68. Further nubbins 83 (seen best in FIGS. 7 and 8) are disposed on the bottom side of each of the locking struts 68 and can engage a further receiver (not shown) on the sliding lip 36 to retain the handle 26 in the retracted position. Further, by placing the handle 26 in the retracted position, the spring 66 is compressed between the bearing surface 32 and the fender 60, thereby pressing the handle 26 upward against the bottoms of the locking struts 68.

In this manner, the handle 26 can be changed from an extended position to a retracted position by rotating the handle 26 in a counterclockwise direction, pushing the handle 26 in, and rotating the handle 26 in a clockwise direction. Other configurations can be employed that are known in the art such that a handle can slide along a shaft and lock in two positions to create a retractable joystick, such as rotating the handle 26 in an opposite direction, or pinning the handle 26.

Referring back to FIG. 4, a speaker 84 can be placed in the knob 20 of the handle 26. The speaker 84 can be employed to produce sounds, including the voice a person with whom the user is speaking or the sound effects of a video game being played on the cellular telephone 10. The speaker 84 is protected by the top surface 22 of the knob 20, which can have at least one front port 85 to allow the sound waves to escape. Rear ports 87 can also be added depending on the acoustics provided by the construction of the housing 11. Wires 86 carrying the electric signal of the sound wave to the loudspeaker 84 can be disposed through the joystick 18 into the cellular phone 10. In this manner, a speaker 84 and joystick 18 can be integrated to minimize the area and volume taken up by the individual components within a cellular telephone 10.

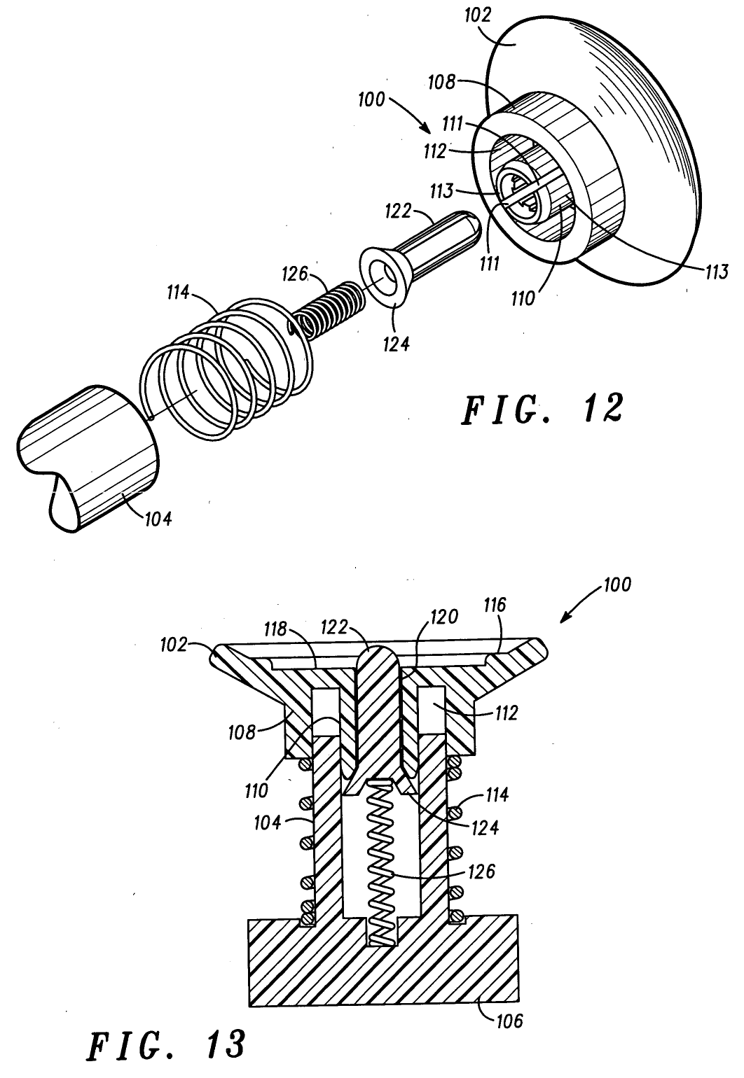

Referring now to FIGS. 11-13, a second example of a retractable joystick 100 suitable for use with a cellular phone is depicted in cross section. The joystick 100 includes a handle 102 that is vertically slidable on a shaft 104 which is attached to a multi-directional input device 106. In this example, the shaft 104 is a cylinder. The shaft 104 and multi-directional input device 106 can work in the previously described manner, or any other manner known in the art, to indicate the direction the joystick 100 is being pointed to the central processing unit of the cellular telephone.

The handle 102 is in a sliding relationship with the shaft 104 and includes an outer cylinder 108 that rides along the outside of the shaft 104, and an inner cylinder 110 that rides along the inside of the shaft 104. The inner cylinder 110 includes slots 111 that define leaves 113. The slots 111 allow the leaves 113 to flex outward. A circumferential slot 112 is defined between the outer cylinder 108 and the inner cylinder 110 and is sized to receive the shaft 104. An outer spring 114 is disposed between the multi-directional input device 106 and the outer cylinder 108 and maintains a force on the handle 102 pushing it vertically.

The handle 102 includes a top surface 116 that has a depression 118 into which a user can place his or her thumb. The handle 102 further includes a hole 120 that is defined by the inner surface of the inner cylinder 110. Disposed in the hole 120 is a button 122. The button 122 includes a wedge 124 on the bottom, which extends outward towards or even to touch the inner surface of the shaft 104. An inner spring 126 is disposed between the button 122 and the multi-directional input device 106 which pushes the button 122 upwards.

As shown in FIG. 11, the handle 102 is in the retracted, or “down” position. In this position, the top surface 116 of the handle 102 can be approximately flush with the housing of the cellular telephone. In the retracted position, the force of the inner spring 126 pushes the button 122 up. As the button 122 rises, the wedge 124 forces the leaves 113 of the inner cylinder 110 outward and against the shaft 104. This creates enough frictional force between and the shaft 104 and the inner cylinder 110 to maintain the handle 102 in the retracted position and to overcome the force of the outer spring 114 urging the handle 102 vertically.

To move the handle 102 from the retracted position to the extended position shown in FIG. 13, the user can press on the button 122 such that button 122 is forced downward and the wedge 124 is no longer in contact with the inner cylinder 110. At this point the wedge 124 no longer forces the leaves 113 of the inner cylinder 110 against the shaft 104, the force of the friction between the inner cylinder 110 and the shaft 104 is reduced, and the outer spring 114 forces the handle 102 upward until the handle 102 hits a stop in the shaft 104 (not shown). The button 122 is then forced upwards by the force of the inner spring 126 until the wedge 124 engages the inner cylinder 110 again. The handle 102 is locked in the extended position again by the force of the wedge 124 on the inner cylinder 110, creating a frictional force between the inner cylinder 110 and the shaft 104. Thus, a user can manipulate the joystick 100 without the handle 102 retracting into the housing. The joystick 100 of this example can be locked into any position in between the retracted position and the extended position.

While the detailed drawings, specific examples and particular formulations given describe exemplary embodiments, they serve the purpose of illustration only. The systems shown and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

1. A retractable joystick, comprising:
a multi-directional input device;
a shaft extending upwardly from the multi-directional input device, the multi-directional input device adapted to read at least one direction in which the shaft pushed; and
a handle disposed over the shaft, wherein the handle is selectable between a retracted position and an extended position.

2. The joystick of claim 1, further comprising a base fixedly disposed on the shaft, the handle being slidable on the base.

3. The joystick of claim 2, wherein the handle is selectable between an extended position and a retracted position by rotating the handle relative to the base.

4. The joystick of claim 3, wherein the handle includes sliding lips extending inward, the base includes locking struts extending outward, and wherein the sliding lips engage the locking struts in the extended position.

5. The joystick of claim 4, wherein the sliding lips are on top of the locking struts when the handle is in the extended position.

6. The joystick of claim 4, wherein the sliding lips are disposed under the locking struts when the handle is in the retracted position.

7. The joystick of claim 4, wherein the base includes passageways between the locking struts.

8. The joystick of claim 2, wherein the base includes a circumferential slot and a spring disposed in the circumferential slot.

9. The joystick of claim 1, the handle further including a skirt extending outward.

10. The joystick of claim 9, wherein the skirt has a constant radius of curvature.

11. The joystick of claim 1, the handle further including a top surface with a depression.

12. The joystick of claim 1, further comprising a speaker disposed within the handle.

13. A method of retracting a joystick, including:
rotating a handle in an extended position relative to a shaft of a multi-directional input device;
pushing the handle down to a retracted position relative to the shaft; and
rotating the handle relative to the shaft to maintain the handle in the down position.

14. A cellular telephone with a retractable joystick, comprising:
a housing for electronic components;
a multi-directional input device fixedly disposed within the housing;
a shaft extending up from the multi-directional input device, the multi-directional input device adapted to read at least one direction in which the shaft is pushed; and
a handle disposed over the shaft, wherein the handle is selectable between an extended position and a retracted position.

15. The cellular telephone of claim 14, further comprising a base fixedly disposed on the shaft, the handle being slidable on the base.

16. The cellular telephone of claim 15, wherein the base includes a circumferential slot and a spring disposed in the circumferential slot.

17. The cellular telephone of claim 15, wherein the handle is selectable between an extended position and a retracted position relative to the base by rotating the handle relative to the base.

18. The cellular telephone of claim 17, wherein the handle includes sliding lips extending inward, the base includes locking struts extending outward, and the sliding lips overlap the locking struts.

19. The cellular telephone of claim 17, wherein the sliding lips are on top of the locking struts when the handle is in the up position.

20. The cellular telephone of claim 18, wherein the sliding lips are under the locking struts when the handle is in the down position.

21. The cellular telephone of claim 18, wherein the base includes passageways between the locking struts.

22. The cellular telephone of claim 14, wherein the handle further includes a skirt extending outward.

23. The cellular telephone of claim 22, wherein the skirt has a constant radius of curvature.

24. The cellular telephone of claim 14, wherein the handle includes a top surface with a depression.

25. The cellular telephone of claim 14, the cellular telephone housing further including a display screen indicating the direction in which the shaft is moved.

26. The cellular telephone of claim 14, further comprising a speaker disposed in the handle.

27. A joystick, comprising:
a multi-directional input device;
a shaft extending from the multi-directional input device, the multi-directional input device adapted to read a direction to which the shaft is pushed;
a handle disposed about the shaft and including a knob; and
a loudspeaker disposed within the knob.

28. The joystick of claim 27, wherein the handle is selectable between an extended position and a retracted position.

29. The joystick of claim 27, further comprising a base fixedly disposed on the shaft, the handle being slidable on the base.

30. The joystick of claim 29, wherein the handle is selectable between an extended position and a retracted position by rotating the handle relative to the base.

31. The joystick of claim 30, wherein the handle includes sliding lips extending inward, the base includes locking struts extending outward, and the sliding lips overlap the locking struts.

32. The joystick of claim 31, wherein the sliding lips are on top of the locking struts when the handle is in the up position.

33. The joystick of claim 31, wherein the sliding lips are under the locking struts when the handle is in the down position.

34. The joystick of claim 31, wherein the base includes passageways between the locking struts.

35. The joystick of claim 30, wherein the base includes a circumferential slot and a spring disposed in the circumferential slot.

36. The joystick of claim 30, wherein the handle further includes a skirt extending outward.

37. The joystick of claim 36, wherein the skirt has a constant radius of curvature.

38. The joystick of claim 30, wherein the handle includes a top surface with a depression.

39. The joystick of claim 30, further comprising a spring biasing the handle up from the base.

40. A cellular telephone, comprising:
a cellular telephone housing;
a base disposed with the housing;
a handle disposed above the base and including a knob, the handle being displaceable relative to the housing in an X direction and a Y direction and rotatable relative to the base;
a spring biasing the handle up from the base;
a loudspeaker disposed within the knob;
a display screen capable of indicating the X direction and the Y direction in which the handle is displaced; and
wherein the handle is selectable between a extended position and a retracted position relative to the base.
